(19) United States
(12) Patent Application Publication
(10) Pub. No.: US 2016/0222964 A1
(43) Pub. Date: Aug. 4, 2016

(54) FUEL PUMP

(71) Applicant: LEISTRITZ PUMPEN GMBH, Numberg (DE)

(72) Inventors: Jürgen METZ, Feucht (DE); Kris ZEMANEK, Lauf an der Pegnitz (DE)

(21) Appl. No.: 15/013,047

(22) Filed: Feb. 2, 2016

(30) Foreign Application Priority Data
Feb. 2, 2015 (DE) 10 2015 101 443.2

(51) Int. Cl. F04C 15/00; F02M 59/12; F04C 2/16

(52) U.S. Cl. CPC F04C 15/0061; F04C 2/16; F04C 15/008; F02M 59/12

(57) ABSTRACT

A fuel pump, having a housing, in which an electric drive motor is accommodated, the motor shaft of which is coupled by a clutch element to a drive screw of a screw pump, wherein the drive screw has a substantially level axial surface at its clutch-side end.

### CROSS-REFERENCE TO RELATED APPLICATIONS

The present application claims priority of DE 10 2015 101 443.2, filed Feb. 2, 2015, the priority of this application is hereby claimed and this application is incorporated herein by reference.

### BACKGROUND OF THE INVENTION

The invention relates to a fuel pump, having a housing, in which an electric drive motor is accommodated, the motor shaft of which is coupled by a clutch element to a drive screw of a screw pump.

In DE 41 23 384 A1, a description is given of a fuel pump, the electric drive motor of which is connected directly to a drive screw, which drives an idler screw, thereby delivering a fluid axially. The drive screw and the idler screw form moving delivery chambers for a fluid, in particular fuel, whereby the fuel is delivered from a suction-side inlet to a discharge-side outlet. There can be a flow of fuel through the electric drive motor, thereby cooling the drive motor.

A dog clutch for a screw pump is known from DE 43 08 755 A1. The dog clutch connects the shaft of the driving motor to the drive screw, thereby compensating for axial misalignment and angular misalignment between the drive shaft and the screw. Two intersecting grooves are ground in at one axial end of the drive screw, thereby giving rise to two mutually opposite dogs with a triangular cross section. The clutch provided there is of disk-shaped design and has two recesses, in which the triangular dogs engage. In addition, the clutch has a central slot, in which the end portion of the drive shaft, which is there referred to as an axle stub, engages.

Although fuel pumps of this kind having a dog clutch have long proven themselves, there is a requirement for an improved fuel pump which can be produced at lower cost.

### SUMMARY OF THE INVENTION

It is therefore the underlying object of the invention to specify a fuel pump which can be produced at lower cost.

To achieve this object, provision is made, according to the invention, for the drive screw in a fuel pump of the type stated at the outset to have a substantially level axial surface at its clutch-side end.

The invention is based on the insight that the production costs for a fuel pump can be reduced if a drive screw with a level axial surface is used. This eliminates the comparatively complex grinding operations by which the two triangular dogs are produced. To achieve this, several successive grinding operations were hitherto required in order to produce one side of the triangular dog in each case. According to the invention, the production of the dogs is omitted, and therefore all that is required is to cut to length the drive screw produced. For this purpose, the first step is to produce a blank, from which a plurality of separate drive screws, e.g. two or three drive screws, can be produced by subdivision. In this way, the production of the individual drive screws can be accomplished efficiently and at low cost. Another advantage can be seen in the fact that the omission of the dogs reduces the length of a drive screw by about 5% in comparison with a conventional drive screw having dogs. Accordingly, a considerable saving of material is thereby achieved.

In the fuel pump according to the invention, it is particularly preferred if the axial surface extends over the entire cross section of the drive screw. This means that, at its clutch-side end, the drive screw has only a single level surface, which can be produced easily by means of a cutting method. The level axial surface is obtained when the blank of the drive screw is divided into a plurality of parts of the same length.

Particularly reliable operation of the fuel pump according to the invention can be ensured if one side of the clutch element is designed as a mirror image of the clutch-side end of the drive screw. Accordingly, this side of the clutch element is designed as the negative of the drive screw and thus has a recess, into which the clutch-side end of the drive screw engages in the assembled state. The clutch element and the clutch-side end of the drive screw are thereby connected to one another positively and/or nonpositively. The clutch element is designed in such a way that it is capable of transmitting the torque output by the motor shaft to the drive screw.

A development of the fuel pump according to the invention envisages that the clutch-side end of the drive screw has ground edges. Grinding the edges serves to avoid sharp edges, which might otherwise damage the clutch element.

With the fuel pump according to the invention, it is preferred if the clutch element is produced from a plastics material by injection molding. In this way, the clutch element can be produced at particularly low cost. In this context, it is particularly preferred if the clutch element is produced from a plastically deformable plastics material. Through an at least slight plastic deformability, a certain adaptation of the deformable plastics material to the drive screw, if appropriate also to the motor shaft, can take place initially, thereby improving power transmission. Since the clutch element and the clutch-side end of the drive screw rest flat against one another, there is a large area available via which the torque introduced or the power is transmitted, and this reduces the surface pressure acting on the clutch element and increases the service life of the clutch element.

The screw pump of the fuel pump according to the invention preferably comprises the drive screw and one or two driven screws.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a sectioned side view of a fuel pump according to the invention;

FIG. 2 shows a side view of a drive screw;

FIG. 3 shows a perspective view of the drive screw shown in FIG. 2;

FIG. 4 shows another perspective view of the drive screw shown in FIG. 2;

FIG. 5 shows a detail of the end of the drive screw with the clutch element mounted;

FIG. 6 shows the opposite side of the clutch element shown in FIG. 5;

FIG. 7 shows a side view of the drive screw with the clutch element mounted; and

FIG. 8 shows a perspective view of the drive screw shown in FIG. 6 with the clutch element mounted.

### DETAILED DESCRIPTION OF THE INVENTION

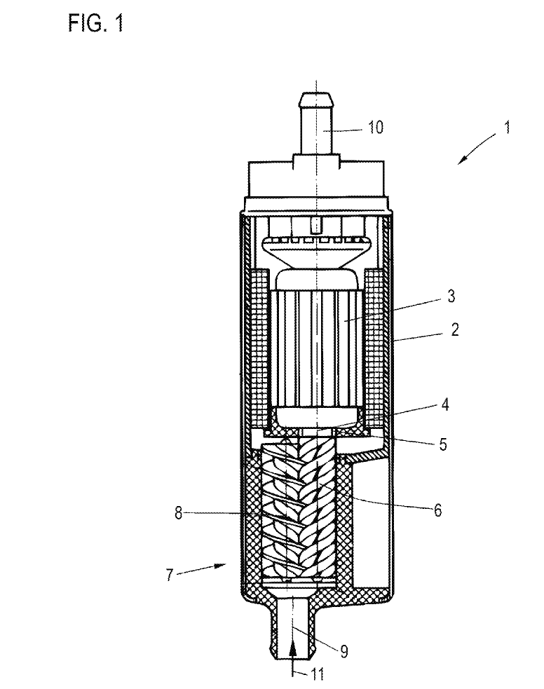

FIG. 1 is a sectioned side view of a fuel pump 1 having a housing 2, in which an electric drive motor 3 is accommodated. A motor shaft 4 of the drive motor 3 is coupled by a clutch element 5 to a drive screw 6 of a screw pump 7, which additionally has a driven screw (idler screw) 8. The housing 2 has a suction-side inlet 9 and a discharge-side outlet 10. During operation, fuel is drawn in in the direction of the arrow 11 and moved in an axial direction by the delivery chambers formed between the drive screw 6, the screw 7 and the surrounding housing, with the result that the fuel flows through the drive motor 3 and leaves the fuel pump 1 at the discharge-side outlet 10. Through appropriate choice of the length of the screws, the motor power and speed, a desired delivery volume and a desired pressure can be defined.

FIG. 2 is a side view and shows the drive screw 6. The drive screw 6 has a screw profile and a level axial surface 13 is formed on the clutch-side end 12 thereof. In FIG. 2, it can be seen that the drive screw 6 has a convexly shaped axial surface 14 at its end opposite the axial surface 13, said axial surface 14 making contact with a key in the assembled state. The drive screw 6 can be produced at low cost since the hitherto customary dogs at one end, which otherwise require additional and complex grinding operations, are dispensed with. Moreover, the drive screw 6 has a reduced length as compared with conventional drive screws, thereby giving a saving of material in the percent range.

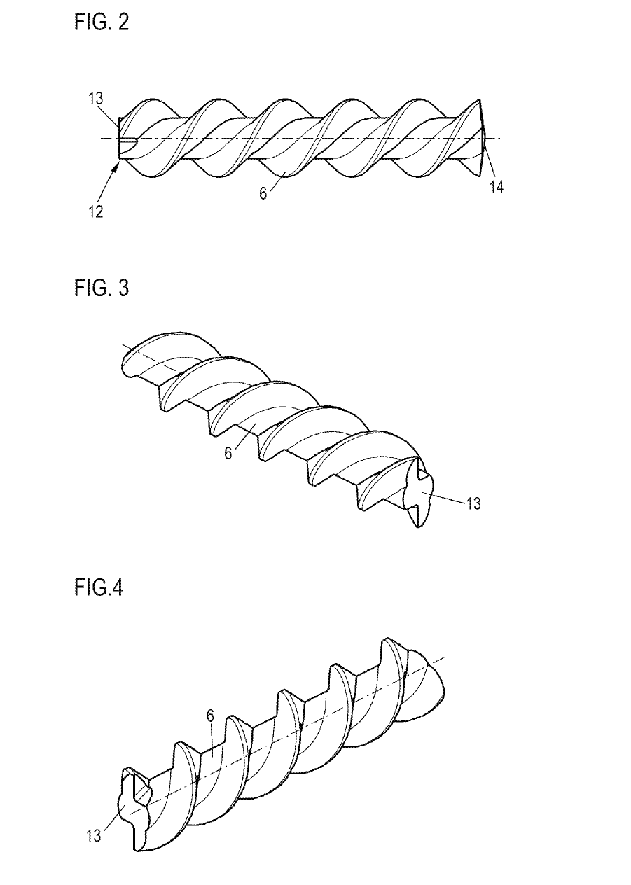

FIG. 3 is a perspective view in which the axial surface 13, in particular, is visible.

In a similar way, FIG. 4 shows another perspective view of the drive screw 6 and of its level axial surface 13.

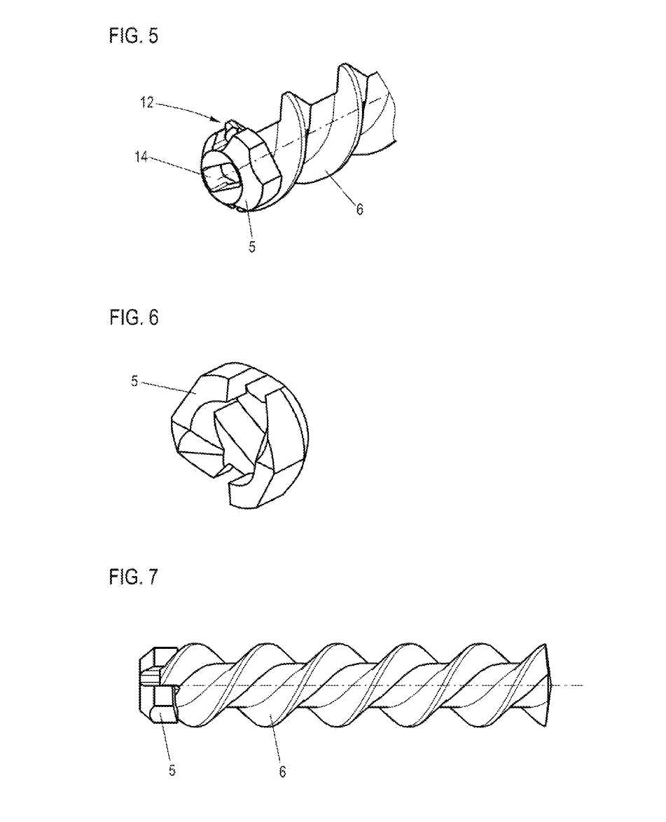

FIG. 5 is an enlarged view of the clutch-side end 12 of the drive screw 6 with the clutch element 5 mounted. The clutch element 5 is produced from a plastics material by injection molding. The plastics material is composed in such a way that it adapts to the outer contour of the end 12 of the drive screw 6, ensuring that it rests flat thereon, thereby reducing surface pressure. Via the contact surfaces at the end 12 of the drive screw 6 and the clutch element, the torque introduced by the motor shaft 4 is introduced into the drive screw 6 via the clutch element 5.

FIG. 6 is a perspective view and shows the clutch element 5 from the opposite side in comparison with FIG. 5. In FIG. 6, it can be seen that the clutch element 5 is designed substantially as a mirror image of the outer contour of the clutch-side end 12 of the drive screw 6. Accordingly, the clutch element 5 can be mounted on the end 12 in such a way that positive engagement and nonpositive engagement are achieved. Sharp edges remaining after the subdivision of the blank are removed at the clutch-side end 12 of the drive screw 6, thereby preventing damage to the clutch element 5. Moreover, deburring ensures that slipping of the clutch element over the drive screw is prevented in the case of rotation of the motor in the opposite direction. The side of the clutch element 5 facing the drive motor 3 can be seen in FIG. 5. The clutch element has a slot 14, which is arranged transversely to the longitudinal direction of the drive screw 6 and is matched to the size and shape of the motor shaft 4. The clutch element 5 additionally serves to compensate for shape tolerances and position tolerances between the motor shaft 4 and the drive screw 6.

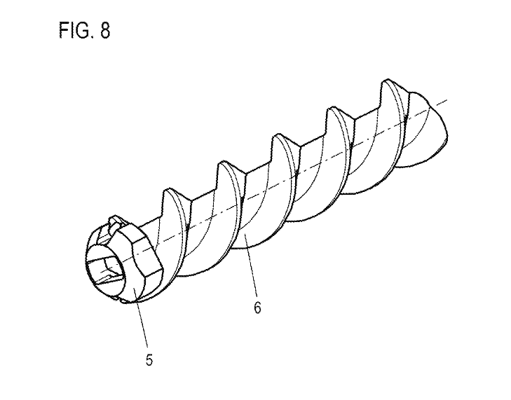

FIG. 7 is a side view and, like FIG. 2, shows the drive screw 6, but with the clutch element 5 mounted.

FIG. 8 is a perspective view of the drive screw 6 in FIG. 7 provided with the clutch element 5.

The significant advantage of the fuel pump 1 is to be seen in the fact that the drive screw 6 can be produced at low cost since production of dogs is dispensed with. Instead, use is made of a clutch element 5 which has a recess matched to the outer contour of the clutch-side end 12 of the drive screw 6. The opposite side of the clutch element 5 is coupled to the motor shaft 4.

While specific embodiments of the invention have been shown and described in detail to illustrate the inventive principles, it will be understood that the invention may be embodied otherwise without departing from such principles.

We claim:

1. A fuel pump, having a housing, in which an electric drive motor is accommodated, the motor shaft of which is coupled by a clutch element to a drive screw of a screw pump, wherein the drive screw has a substantially level axial surface at its clutch-side end.

2. The fuel pump according to claim 1, wherein the axial surface extends over the entire cross section of the drive screw.

3. The fuel pump according to claim 1, wherein one side of the clutch element is designed as a mirror image of the clutch-side end of the drive screw.

4. The fuel pump according to claim 1, wherein the clutch element and the clutch-side end of the drive screw are connected positively and/or nonpositively to one another.

5. The fuel pump according to claim 1, wherein the clutch-side end of the drive screw has ground edges.

6. The fuel pump according to claim 1, wherein the clutch element is produced from a plastics material by injection molding.

7. The fuel pump according to claim 1, wherein the clutch element is produced from a plastically deformable plastics material.

8. The fuel pump according to claim 1, wherein it has the drive screw and one or two driven screws.
